(19) United States
(12) Patent Application Publication
(10) Pub. No.: US 2009/0238259 A1
(43) Pub. Date: Sep. 24, 2009

(54) METHOD OF RATE CONTROL FOR VIDEO FRAME COMPRESSION AND ENCODER THEREOF

(76) Inventor: Sung-Hung Yeh, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/051,840

(22) Filed: Mar. 19, 2008

(51) Int. Cl. H04N 7/28

(52) U.S. Cl. 375/240.01

(57) ABSTRACT

A method for encoding a video frame includes segmenting a video frame into a plurality of frame segments; compressing a frame segment according to a plurality of compression rates to generate a plurality of coded outputs; selecting an actual coded output from the plurality of coded outputs based on a target rate; and packing the actual coded output to generate compressed data. A video frame encoder includes: a segment unit used for segmenting a video frame into a plurality of frame segments; a data compressing module used for compressing a frame segment according to a plurality of compression rates to generate a plurality of coded outputs; a selecting module used for selecting an actual coded output from the plurality of coded outputs based on a target rate; and a packing unit used for packing the actual coded output to generate compressed data.

### BACKGROUND OF THE INVENTION

The present invention relates to video frame compression, and more particularly, to a method of rate control for frame buffer compression and an apparatus thereof.

High-resolution and high-color Liquid Crystal Displays (LCDs) have become widely produced to meet the ever-growing need for display technology. In general, the frame buffer for storing images that will be displayed on a high-resolution and high-color LCD requires high activities of frame buffer access. This high-activity-access behavior takes up a great deal of bandwidth and results in large power consumption and shortens the battery usage time. Thus, there is a need for compressing data stored in the frame buffer. In conventional compression algorithms, such as lossless compression (LZW or LZ77) and lossy compression (JPEG), the compression rate is difficult to be precisely controlled. The compressed frame size therefore cannot be predicted and a large storage space needs to be reserved for storing compressed frames, resulting in inefficient memory utilization of frame buffer. In addition, when the compression rate is unable to be precisely controlled, random access is not allowed and “partial update” for refreshing the frame stored in the frame buffer cannot be executed. “Partial update” is understood as only updating some portion(s) of the frame when a current frame has little changes with respect to its previous frame. For example, the LCD controller only updates the part that is different to the previous frame rather than updating the whole frame in the frame buffer. As a result, a compression algorithm for frame buffer compression that is capable of compressing frames at a predetermined compression rate in order to achieve efficient memory utilization and random access function is desirable.

### SUMMARY OF THE INVENTION

It is therefore one of the objectives of the present invention to provide a rate control method and a related apparatus for video frame compression in order to meet the above-mentioned criteria.

According to an exemplary embodiment of the claimed invention, a method of rate control for video frame compression is disclosed. The method comprises: segmenting a video frame into a plurality of segments; compressing a segment according to a plurality of compression rates to generate a plurality of coded outputs respectively corresponding to the plurality of compression rates; selecting an actual coded output from the plurality of coded outputs based on a target rate; and packing the actual coded output to generate compressed data.

According to an exemplary embodiment of the claimed invention, a video frame encoder comprises a segment unit, a data compressing module, a selecting module and a packing unit. The segment unit is used for segmenting a video frame into a plurality of segments, for example, each segment has 8 pixels for each RGB component. The data compressing module is used for compressing a segment according to a plurality of compression rates to generate a plurality of coded outputs respectively corresponding to the plurality of compression rates. The selecting module is used for selecting an actual coded output from the plurality of coded outputs based on a target rate. The packing unit is used for packing the actual coded output to generate compressed data.

An embodiment of a frame buffer compression system comprises a video frame encoder, a memory, and a corresponding video frame decoder. The video frame encoder segments and compresses a video frame with various compression rates, selecting one of the compression rates based on a target rate, and packing an coded output corresponding to the selected compression rate into compressed data. The memory stores the compressed data and the video frame decoder decompresses the compressed data for video display.

These and other objectives of the present invention will no doubt become obvious to those of ordinary skill in the art after reading the following detailed description of the preferred embodiment that is illustrated in the various Figures and drawings.

### BRIEF DESCRIPTION OF THE DRAWINGS

FIG. 1 is a block diagram illustrating a video frame encoder according to an embodiment of the present invention.

FIG. 2 is a flowchart illustrating a method for encoding video frame according to an embodiment of the present invention.

FIG. 3 is an exemplary block diagram for a simple DPCM encoder.

FIG. 4 is an exemplary block diagram for a simple DPCM decoder.

FIG. 5 is a block diagram illustrating an embodiment of a frame buffer compression system.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

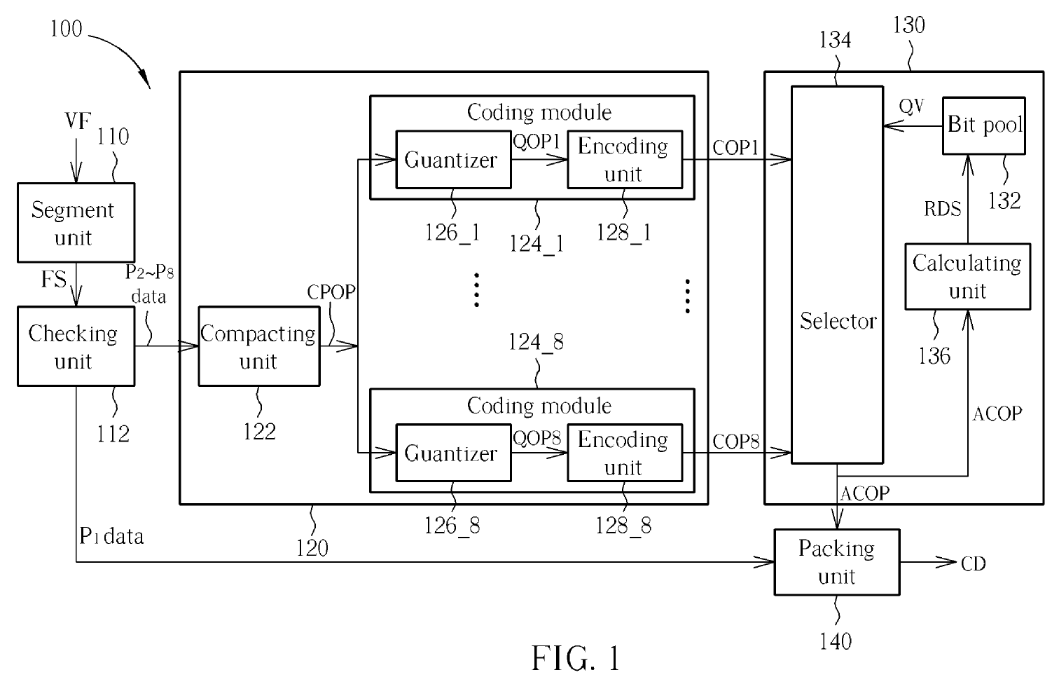

Please refer to FIG. 1. FIG. 1 is a block diagram illustrating a video frame encoder 100 according to an embodiment of the present invention. The video frame encoder 100 is configured to compress a video frame according to a predetermined compression rate. As shown in FIG. 1, the video frame encoder 100 comprises a segment unit 110, which is utilized for segmenting a video frame into a plurality of frame segments; a data compressing module 120, which is utilized for compressing the video frame in segments, wherein each frame segment is compressed by the data compressing module 120 according to different compression rates to generate a plurality of coded outputs; a selecting module 130, which is utilized for selecting an actual coded output from the plurality of coded outputs; and a packing unit 140, which is utilized for packing the actual coded output to generate compressed data. Further description of the video frame encoder 100 is detailed as follows.

The segment unit 110 of the video frame encoder 100 initially segments a video frame VF, which is composed of numerous pixels, into a plurality of frame segments in a line-by-line manner where one frame segment has M pixels and M is a positive integer. In the case of M=8, a frame segment has eight pixels P₁, P₂, . . . , P₈. Please note that M=8 is only for illustrative purposes and is not a limitation of the present invention. In some embodiments, each segment comprises 8 pixels for each component in an RGB signal. The video frame encoder 100 further comprises a checking unit 112 for checking whether data of a frame segment FS belongs to a first pixel in the frame segment FS. For example, if the data being a first pixel (e.g., the data of pixel PI) is determined, the checking unit 112 directly outputs the data to the packing unit 140; otherwise, the checking unit 112 outputs the data, which is not a first pixel data (e.g., the data of pixels P₂ P₈), to the data compressing module 120.

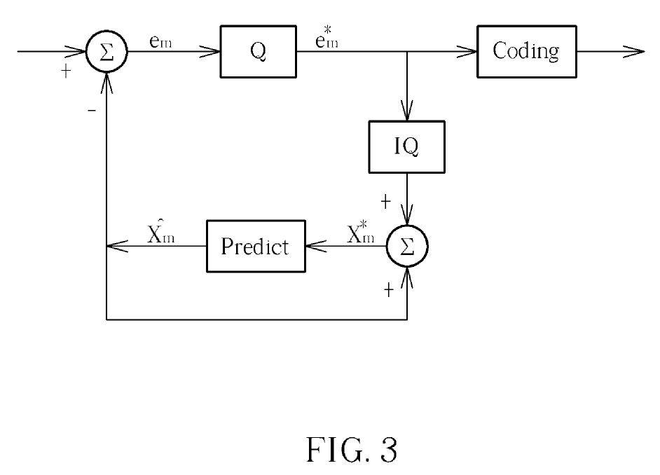

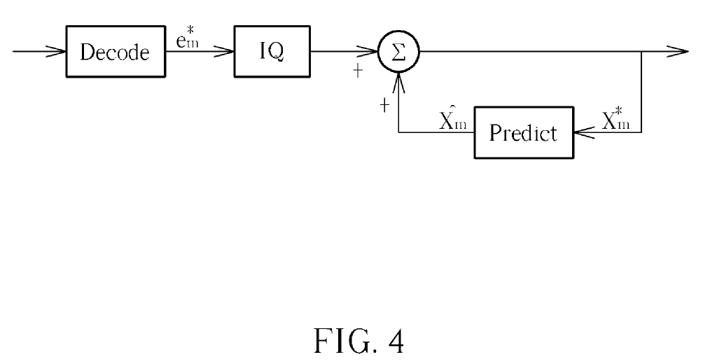

The data compressing module 120 comprises a compacting unit 122 and a plurality of coding modules 124. Each of the coding modules 124 comprises a quantizer 126 and an encoding unit 128. The compacting unit 122 compacts the data received from the checking unit 112 (e.g., the data of pixels P₂˜P₈) to generate a compacted output CPOP. Each quantizer 126_1, 126_2, . . . , 126_8 respectively corresponds to a predetermined quantization value and quantizes the compacted output CPOP according to the predetermined quantization value to generate a quantized output QOP. Each of the encoding units 128_1, 128_2, 128_8 respectively connects to the quantizers 126_1, 126_2, . . . , 126_8 and encodes the quantized output QOP received from the connected quantizer according to a modified exp-Golomb coding algorithm to generate a coded output COP and outputs the coded output COP into the selecting module 130. In this embodiment, the compacting unit 122 is a differential pulse code modulator (DPCM) and compacts data with a differential pulse code modulation. A DPCM system reduces both the time and cost of transmitting a signal over a narrow bandwidth by transmitting only the digitally encoded differences between successive sample values. In a DPCM encoder, the value of an image sample is predicted and the difference between the actual and the predicted value is quantized and transmitted. At the DPCM decoder, a similar predictor uses the transmitted values of the quantized difference signal to reconstruct the scanned image sample. Exemplary block diagrams for a simple DPCM encoder and DPCM decoder are shown in FIGS. 3 and 4.

In addition, the data compressing module 120 of this embodiment has eight coding modules 124_1, 124_2, . . . , 124_8; however, the number of coding modules shown here is for illustrative purposes and is not a limitation of the present invention. The predetermined quantization value of the quantizer in each of the coding modules is different, for example, the quantization values are 1, 2, 4, 8, 16, 32, 64, and 128, so the compacted output CPOP is converted into eight distinct coded outputs COP1, COP2, . . . , COP8 by the compressing module 120.

The selecting module 130 comprises a bit pool 132, a selector 134 and a calculating unit 136. The bit pool 132 buffers a quota value QV. The selector 134 selects an actual coded output ACOP from the plurality of coded outputs COPs received from the compressing module 120 according to the quota value QV and a target rate, and outputs the actual coded output ACOP to the packing unit 140. The calculating unit 136 updates the quota value QV buffered in the bit pool 132 according to the actual coded output ACOP and the quota value QV. In this embodiment, the quota value QV is a data size quota for the actual coded output ACOP. In general, the greater the predetermined quantization value, the smaller the data size of the coded output. When the predetermined quantization value increases, however, more data information is lost. To obtain the optimum relationship of data size and data information by considering the target rate, the selector 134 selects a coded output, whose data size is closest to, but not more than, the data size quota to be the actual coded output ACOP from the plurality of coded outputs COPs and outputs the actual coded output ACOP to the packing unit 140. The calculating unit 136 calculates a residual data size RDS by subtracting a data size of the actual coded output ACOP from the data size quota and updates the data size quota by adding the residual data size RDS to the data size quota. The next actual coded output ACOP is selected according to the updated data size quota.

For example, in this embodiment the video frame encoder 100 is supposed to compress the video frame with 50% compression rate and there are 192 bits data in a frame segment for eight pixels. The data size quota is predetermined to be 192*50%=96 bits. The accumulated data size for the eight pixels corresponding to the eight coded outputs COP1, COP2, . . . , COP8 generated based on eight different quantization values are assumed to be 154, 130, 111, 90, 83, 67, 46 and 31 bits respectively. Since 90 bits for COP4 is closest to (and not over) 96 bits, the selector 134 selects COP4 to be the actual coded output ACOP for the frame segment. The calculating unit 136 therefore calculates the residual data size to be 96−90=6 bits and updates the data size quota to be 96+6=102 bits. The accumulated data sizes of the next eight pixels (next frame segment) after compression with the eight quantization values are assumed to be 114, 108, 98, 91, 85, 71, 52 and 36 bits respectively. Since the updated data size quota is equal to 102 bits, the selector 134 selects COP3 (with data size 98) to be the actual coded output ACOP. The calculating unit 136 calculates the residual data size to be 102−98=3 bits and updates the data size quota to be 96+3=99 bits for a next actual coded output selection, and so on.

The packing unit 140 packs the data of pixels P₁ of the frame segment FS received from the checking unit 112 and the actual coded output ACOP of the data of pixels P₂˜P₈ of the frame segment FS received from the selecting module 130 to generate compressed data CD corresponding to the frame segment FS. The compressed data CD records the quantization value used to compress the frame segment FS.

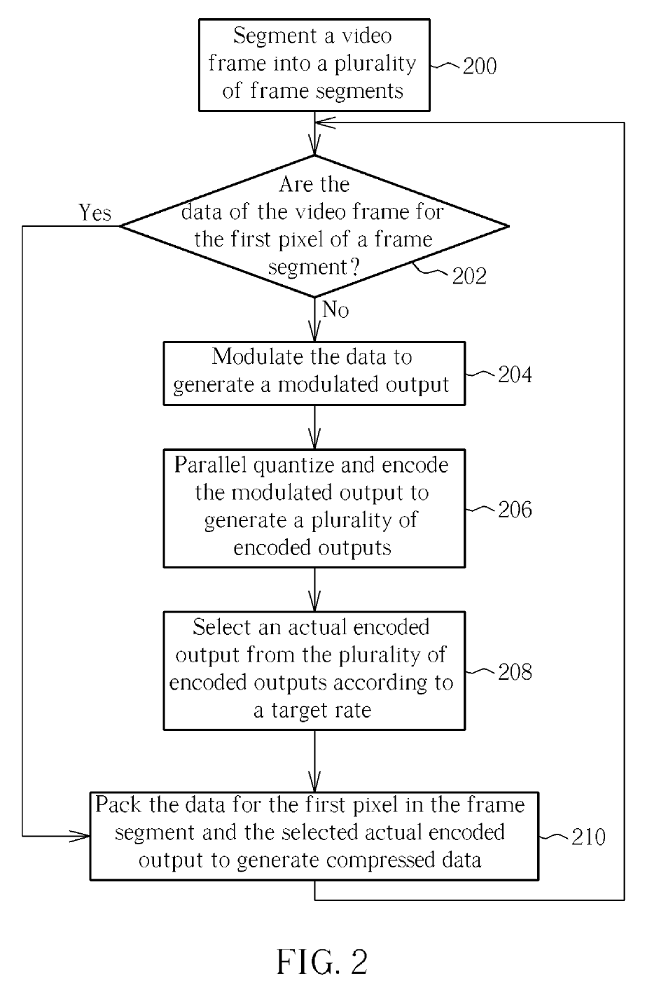

Please refer to FIG. 2. FIG. 2 is a flowchart illustrating a method for encoding a video frame according to an embodiment of the present invention. Provided that the result is substantially the same, the steps are not limited to be executed in the exact order shown in FIG. 2. The exemplary video frame encoding method can be employed by the video frame encoder 100 shown in FIG. 1, and is summarized as below.
Step 200: Segment a video frame into a plurality of frame segments;
Step 202: Are the data of the video frame for the first pixel of a frame segment? If yes, go to step 210; otherwise, go to step 204;
Step 204: Modulate the data to generate a modulated output;
Step 206: Parallel quantize and encode the modulated output to generate a plurality of encoded outputs;
Step 208: Select an actual encoded output from the plurality of encoded outputs according to a target rate;
Step 210: Pack the data for the first pixel in the frame segment and the selected actual encoded output to generate compressed data.

As a skilled person can readily understand the exact operation of each step in FIG. 2 after reading the aforementioned disclosure, further description is omitted here for brevity.

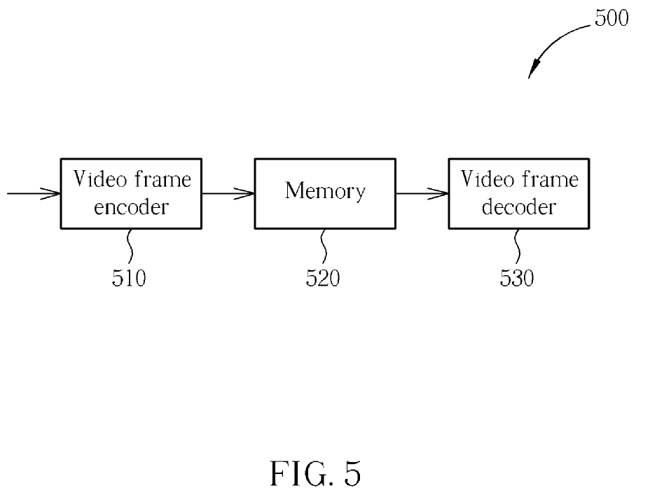

FIG. 5 illustrates an embodiment of a frame buffer compression system 500, comprising a video frame encoder 510, a memory 520, and a video frame decoder 530. The video frame encoder 510 may have the same or similar structure as the one shown in FIG. 1. Some embodiments of the video frame encoder 510 conduct parallel rate decision using DPCM with exp-Golomb code to compress video frames to be stored into the memory 520. Data of the video frame are segmented and encoded by computing a difference between each pixel, quantizing the difference with various quantization values and encoding into codewords using exp-Colomb coding in parallel. For each quantization value, the length of the codeword corresponding to the same segment is accumulated. The accumulated lengths for the various quantization values are compared to a quota value, and a best matched quantization value is selected. The coded output corresponding to the best matched quantization value is packed as compressed data for storing in the memory 520. The video frame decoder 530 retrieves the compressed data from the memory 520 when the video frame is requested from the display end.

Embodiments of the video frame encoder 510 and the frame buffer compression system 500 illustrated above allow partial update of a video frame because the compressed data has fixed bit rate for each line or each segment which makes random access possible.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of rate control for video frame compression, comprising:
segmenting a video frame into a plurality of frame segments;
compressing a frame segment according to a plurality of compression rates to generate a plurality of coded outputs respectively corresponding to the compression rates;
selecting an actual coded output from the plurality of coded outputs based on a target rate; and
packing the actual coded output to generate compressed data.

2. The method of claim 1, wherein the step of compressing the frame segment comprises:
compacting the frame segment to generate a compacted output; and
coding the compacted output according to the plurality of compression rates to generate the coded outputs.

3. The method of claim 2, wherein the step of coding the compacted output comprises:
quantizing the compacted output according to a predetermined quantization value to generate a quantized output; and
encoding the quantized output to generate a coded output.

4. The method of claim 3, wherein the step of compacting the frame segment comprises calculating a difference between a current value and a previous value.

5. The method of claim 3, wherein the step of encoding the quantized output comprises transforming the quantized output into a codeword based on a modified exp-Golomb coding algorithm.

6. The method of claim 1, wherein the step of selecting the actual coded output comprises:
buffering a quota value;
selecting the actual coded output from the plurality of coded outputs according to the quota value and the target rate; and
updating the quota value according to the actual coded output.

7. The method of claim 6, wherein the quota value is a data size quota and the step of selecting the actual coded output from the plurality of coded outputs compares the data size quota and data sizes of the plurality of coded outputs.

8. The method of claim 7, wherein the step of selecting the actual coded output further comprises selecting a coded output whose data size is closest to, but not more than, the data size quota as the actual coded output.

9. The method of claim 6, wherein the step of updating the quota value comprises adding a difference between the data size quota and a data size of the actual coded output to the data size quota.

10. The method of claim 1, wherein the step of segmenting segments the video frame in a line-by-line manner.

11. A video frame encoder, comprising:
a segment unit, segmenting a video frame into a plurality of frame segments;
a data compressing module, coupled to the segment unit, compressing a frame segment according to a plurality of compression rates to generate a plurality of coded outputs respectively corresponding to the plurality of compression rates;
a selecting module, coupled to the data compressing module, selecting an actual coded output from the plurality of coded outputs based on a target rate; and
a packing unit, coupled to the selecting module, packing the actual coded output to generate compressed data.

12. The video frame encoder of claim 11, wherein the data compressing module comprises:
a compacting unit, coupled to the segment unit, for compacting the frame segment to generate a compacted output; and
a plurality of coding modules, coupled to the compact unit, coding the compacted output according to the plurality of compression rates to generate the coded outputs.

13. The video frame encoder of claim 12, wherein each of the coding modules comprises:
a quantizer, coupled to the compacting unit, quantizing the compacted output according to a predetermined quantization value to generate a quantized output; and
an encoding unit, coupled to the quantizer, for encoding the quantized output to generate a coded output.

14. The video frame encoder of claim 13, wherein the compacting unit is a differential pulse code modulator (DPCM).

15. The video frame encoder of claim 13, wherein the encoding unit encodes the quantized output according to a modified exp-Golomb coding algorithm.

16. The video frame encoder of claim 11, wherein the selecting module comprises:
a bit pool, buffering a quota value;
a selector, coupled to the bit pool, selecting the actual coded output from the plurality of coded outputs according to the quota value and the target rate; and
a calculating unit, coupled to the selector and the bit pool, for updating the quota value in the bit pool according to the actual coded output and the quota value.

17. The video frame encoder of claim 16, wherein the quota value is a data size quota and the selector compares the data size quota and data sizes of the plurality of coded outputs to select the actual coded output from the plurality of coded outputs.

18. The video frame encoder of claim 17, wherein the selector selects a coded output whose data size is closest to, but not more than, the data size quota as the actual coded output.

19. The video frame encoder of claim 16, wherein the calculating unit updates the quota value by adding a difference between the data size quota and a data size of the actual coded output to the data size quota.

20. The video frame encoder of claim 11, wherein the segment unit segments the video frame in a line-by-line manner.

21. A frame buffer compression system, comprising:
a video frame encoder, comprising:
a segment unit, segmenting a video frame into a plurality of frame segments;
a data compressing module, coupled to the segment unit, compressing a frame segment according to a plurality of compression rates to generate a plurality of coded outputs respectively corresponding to the plurality of compression rates;
a selecting module, coupled to the data compressing module, selecting an actual coded output from the plurality of coded outputs based on a target rate; and
a packing unit, coupled to the selecting module, packing the actual coded output to generate compressed data;
a memory, storing the compressed data output from the video frame encoder; and
a video frame decoder, decoding the compressed data stored in the memory for display.

22. The frame buffer compression system of claim 21, wherein the data compressing module comprises:
a compacting unit, coupled to the segment unit, for compacting the frame segment to generate a compacted output; and
a plurality of coding modules, coupled to the compact unit, coding the compacted output according to the plurality of compression rates to generate the coded outputs.

23. The frame buffer compression system of claim 22, wherein each of the coding modules comprises:
a quantizer, coupled to the compacting unit, quantizing the compacted output according to a predetermined quantization value to generate a quantized output; and
an encoding unit, coupled to the quantizer, for encoding the quantized output to generate a coded output.

24. The frame buffer compression system of claim 23, wherein the compacting unit is a differential pulse code modulator (DPCM).

25. The frame buffer compression system of claim 23, wherein the encoding unit encodes the quantized output according to a modified exp-Golomb coding algorithm.

26. The frame buffer compression system of claim 21, wherein the selecting module comprises:
a bit pool, buffering a quota value;
a selector, coupled to the bit pool, selecting the actual coded output from the plurality of coded outputs according to the quota value and the target rate; and
a calculating unit, coupled to the selector and the bit pool, for updating the quota value in the bit pool according to the actual coded output and the quota value.

27. The frame buffer compression system of claim 26, wherein the quota value is a data size quota and the selector compares the data size quota and data sizes of the plurality of coded outputs to select the actual coded output from the plurality of coded outputs.

28. The frame buffer compression system of claim 27, wherein the selector selects a coded output whose data size is closest to, but not more than, the data size quota as the actual coded output.

29. The frame buffer compression system of claim 26, wherein the calculating unit updates the quota value by adding a difference between the data size quota and a data size of the actual coded output to the data size quota.

30. The frame buffer compression system of claim 21, wherein the segment unit segments the video frame in a line-by-line manner.
